(19) United States
(12) Patent Application Publication
(10) Pub. No.: US 2016/0295902 A1
(43) Pub. Date: Oct. 13, 2016

(54) FREEZE DRY FOODSTUFF FINISHING SYSTEM AND METHOD

(71) Applicant: Joshua Kingdon, Las Vegas, NV (US)

(72) Inventor: Joshua Kingdon, Las Vegas, NV (US)

(21) Appl. No.: 14/683,043

(22) Filed: Apr. 9, 2015

(51) Int. Cl. A23L 3/44; F26B 5/06; A23B 7/024

(52) U.S. Cl. CPC A23L 3/44; A23B 7/024; F26B 5/06; A23V 2002/00

(57) ABSTRACT

A freeze dry foodstuff finishing process and system produces foodstuffs that are ready for immediate consumption and preserved, while reducing or eliminating the need for chemical preservatives. The foodstuff finishing process generally comprises a plurality of drying steps with an intervening freezing step, which may be performed by a system comprising one or more ovens, freezers and freeze dryers. Foodstuffs will typically be prepared with one or more flavorings before the finishing process occurs.

### BACKGROUND OF THE INVENTION

1. Field of the Invention

The invention relates to food preparation systems and methods and in particular to a freeze dry foodstuff finishing process and system therefor.

2. Related Art

Naturally preserved food is desirable for its reduced or lack of artificial preservatives. In addition, food prepared without fewer or no chemical processes is also desirable, especially to those that are health conscious or conscientious eaters. However, so-called junk food remains appetizing and, in many cases, very tempting.

From the discussion that follows, it will become apparent that the present invention addresses the deficiencies associated with the prior art while providing numerous additional advantages and benefits not contemplated or possible with prior art constructions.

### SUMMARY OF THE INVENTION

A freeze dry foodstuff finishing process and system are disclosed herein. The finishing process and system is advantageous in that it produces foodstuffs that are ready for immediate consumption and preserved. In addition, finishing process and system typically eliminates the need for chemical preservatives. Also, the finishing process and system alters the texture and concentrates the flavor of foodstuffs.

Various processes and systems for the finishing process are disclosed herein. For instance, in one exemplary embodiment, a method for finishing sweet potatoes with a foodstuff finishing system is disclosed, with such method comprising slicing one or more raw sweet potatoes into a plurality of sweet potato slices, applying one or more flavorings to the plurality of sweet potato slices, and heat drying and baking the plurality of sweet potato slices in an oven.

The method also includes removing the plurality of sweet potato slices from the oven and freezing the plurality of sweet potato slices in a freezer after heat drying and baking the plurality of sweet potato slices, and removing the plurality of sweet potato slices from the freezer and freeze drying the plurality of sweet potato slices in a freeze drier after freezing the plurality of sweet potato slices. After the plurality of sweet potato slices are freeze dried, the plurality of sweet potato slices are ready for immediate consumption.

The plurality of sweet potato slices may be packaged in various enclosures with a packaging machine after the plurality of sweet potato slices are freeze dried. In addition, the plurality of sweet potato slices may be consumed after the plurality of sweet potato slices are freeze dried. The plurality of sweet potato slices may be 3/16 inch in thickness. A sauce or marinade may be applied to the plurality of sweet potato slices as well. Heat drying and baking the plurality of sweet potato slices may occur within a range of 300° F. to 400° F. for 15 to 25 minutes in the oven for each individual sweet potato quantity.

In another exemplary embodiment, a method for finishing sweet potatoes with a foodstuff finishing system is disclosed, with such method comprising heating a plurality of sweet potato slices with an oven to dry and bake the plurality of sweet potato slices, freezing the plurality of sweet potato slices in a freezer after heating the plurality of sweet potato slices, and freeze drying the plurality of sweet potato slices in a freeze dryer after the plurality of sweet potato slices are frozen. After the plurality of sweet potato slices are freeze dried, the plurality of sweet potato slices are ready for immediate consumption.

The method also may include flavoring the plurality of sweet potato slices prior to heating the plurality of sweet potato slices. In addition, the plurality of sweet potato slices may be packaged in various enclosures with a packaging machine after the plurality of sweet potato slices are freeze dried. The plurality of sweet potato slices may also be consumed after the plurality of sweet potato slices are freeze dried. A sauce or marinade may be applied to the plurality of sweet potato slices as well.

It is noted that heating the plurality of sweet potato slices may occur within a range of 300° F. to 400° F. for 15 to 25 minutes in the oven for each individual sweet potato. Also, similar to above, the plurality of sweet potato slices may be 3/16 inch in thickness.

Various systems are disclosed herein as well. For example, a freeze dry foodstuff finishing system is disclosed in one embodiment, such system comprising one or more ovens that receive a plurality of sweet potato slices and dry and bake the plurality of sweet potato slices, one or more freezers that receive and freeze the plurality of sweet potato slices after the sweet potato slices have been dried and baked by the ovens, and one or more freeze driers that receive and freeze dry the plurality of sweet potato slices after the sweet potato slices have been frozen by the freezers. After the plurality of sweet potato slices are freeze dried by the freeze driers, the plurality of sweet potato slices are ready for immediate consumption.

The ovens may heat and dry the plurality of sweet potato slices within a range of 300° F. to 400° F. for 15 to 25 minutes. A conveyor system that moves the plurality of sweet potato slices between the ovens, the freezers, and the freeze driers may be included as well. One or more packaging machines may package the plurality of sweet potato slices after the plurality of sweet potato slices are freeze dried. One or more programmable logic controllers may control the heating and drying, freezing and freeze drying of the plurality of sweet potato slices. The plurality of sweet potato slices may be 3/16 inch in thickness as well.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a flow diagram illustrating an exemplary foodstuff preparation and finishing process;

FIG. 2 is a flow diagram illustrating an exemplary foodstuff preparation and finishing process;

FIG. 3 is a flow diagram illustrating an exemplary freeze dry foodstuff finishing process; and

FIG. 4 is a block diagram illustrating an exemplary freeze dry foodstuff finishing system.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The freeze dry foodstuff finishing system herein preserves food without the need for chemical preservatives. In addition, as will be described further below, the freeze dry foodstuff finishing system also alters the texture of the food it finishes through a final freeze drying step. Various methods relating to the freeze dry foodstuff finishing process and system are disclosed herein as well. Though described herein primarily with regard to potatoes, namely sweet potatoes, it is contemplated that a variety of foodstuffs may be finished by the freeze dry foodstuff finishing system. Some examples of foodstuffs include root and other vegetables, fruits, tubers, and various meats.

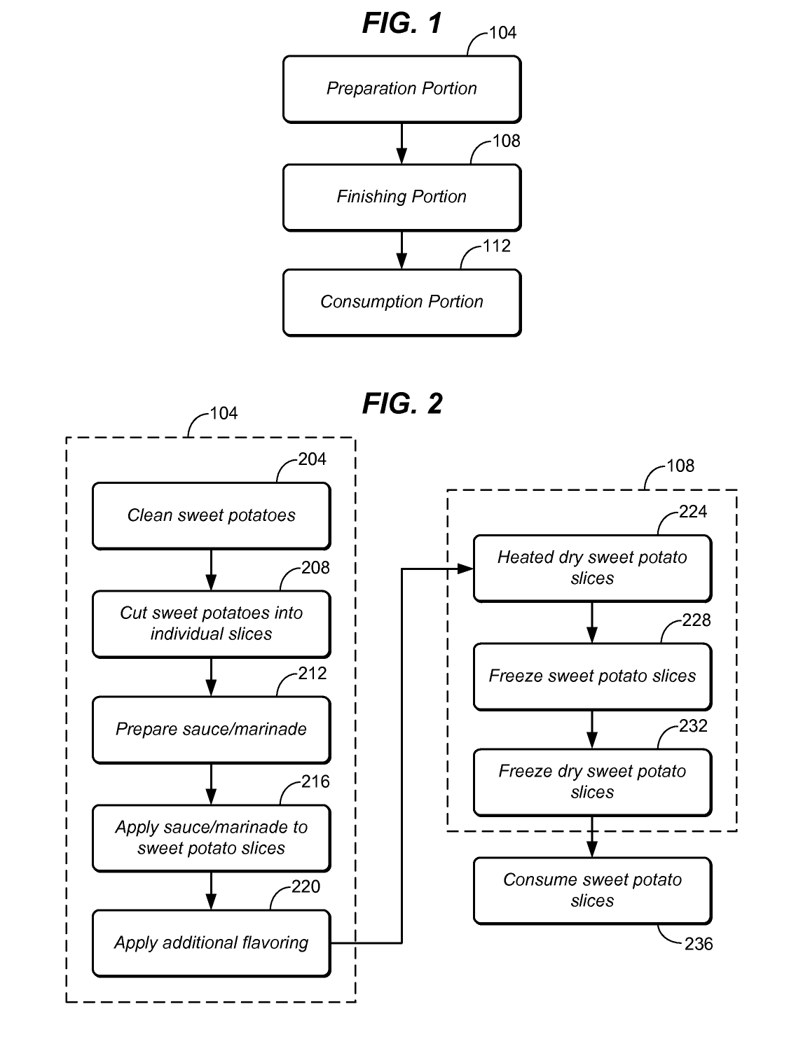

FIG. 1 is a simplified flow diagram provided to illustrate a process by which foodstuffs may be prepared and finished using the freeze dry foodstuff finishing system. As can be seen, foodstuff preparation typically occurs at an initial portion 104 of the process, with the finishing process occurring at a subsequent portion 108.

As can be seen, the finishing portion 108 results in foodstuffs that are ready for immediate consumption, without rehydration or other processing of the foodstuffs. In FIG. 1, this is illustrated by a consumption portion 112 of the process. It is noted that foodstuffs may be packaged such as for storage, transport, or both before consumption. However, packaging is not a preparation or finishing process, and may be omitted as well since foodstuffs finished by the freeze dry foodstuff finishing system are ready for immediate consumption, as stated above.

FIG. 2 is a flow diagram illustrating an exemplary freeze dry foodstuff finishing process with sweet potatoes as the foodstuffs. As can be seen, the sweet potatoes are first prepared at a preparation portion 104 and then finished at a finishing portion 108, such as described briefly above. The preparation portion 104 generally includes preparing foodstuffs for the finishing portion 108. Such preparation may include cooking, seasoning or flavoring of foodstuffs. Preparation may also include physical processing of foodstuffs, such as cleaning, peeling, slicing and/or cutting to remove unwanted material or size/shape foodstuffs.

With reference to FIG. 2, at a step 204, a desired quantity of sweet potatoes are washed or cleaned. Such cleaning may include removing the skin of a sweet potato. At a step 208, the sweet potatoes may be cut into slices of various widths. Typically, a 3/16 inch cut will be used. At a step 212, a sauce or marinade may be prepared such as by coconut or other edible oil and then adding one or more flavorings to the oil. It is noted that if solid, the oil may first be melted or liquified before flavoring is added. In this example, the flavoring comprises cinnamon. In one or more embodiments, ½ cup of oil and ½ teaspoon of flavoring will be used for each sweet potato. The sauce can then be applied to sweet potato slices at a step 216, such that the sauce can coat or marinate the sweet potato slices.

It is contemplated that one or more additional flavoring steps may be employed. For example, at a step 220, salt, dextrose or both may be applied. In one or more embodiments, such flavoring may be applied directly to the sweet potatoes. Alternatively, the flavoring may be indirectly applied such as by sprinkling, coating or otherwise applying flavoring to a bake pan or other surface. Individual flavorings may be applied layer by layer.

Specifically with regard to the sweet potatoes, a layer of salt and a layer of dextrose may be applied to a bake pan. As discussed, such application may occur by spreading, sprinkling, pouring or otherwise applying the salt and dextrose. As the sweet potato slices are placed on the bake pan they are further flavored or seasoned through physical contact with the flavorings.

The sweet potato slices will typically have a planar shape with two sides. Typically, each sweet potato slice will be placed on a bake pan (or tray, conveyer belt, or other supporting surface) on one of the sides. The other side can also be flavored or seasoned as well. To illustrate, in this example, a layer of salt and a layer of dextrose is applied once the sweet potato slices are on the bake pan. The sweet potato slices can then be considered ready for finishing at the finishing portion 108. As stated above, various techniques and ingredients may be used to prepare foodstuffs to a desired configuration during the preparation portion 104. This includes a variety of flavorings, sauces and marinades.

A finishing portion 108 may begin at a step 224 where an initial heat driven drying procedure occurs. Typically, this comprises heating foodstuffs in dry air for a predefined period of time. For example, the sweet potato slices are heated in dry air at 315° F. for 20 minutes. It is contemplated that other temperatures and durations may be used as well. For instance, a temperature between 300° F. to 400° F. for 15 to 25 minutes. In addition, it is noted that temperatures that cook or bake foodstuffs may be selected and used during the drying procedure of step 224.

Thereafter, the sweet potato slices may be frozen at a step 228. Freezing will typically mean lowering the temperature of foodstuffs to their eutectic point. A eutectic point may defined for various foodstuffs, such as for example −30° F. for sweet potato slices. Once frozen, the sweet potato slices may be freeze dried at a step 232. The sweet potato slices are then ready to eat and indeed may be eaten at a step 236. The finishing portion 108 results in sweet potato slices with an altered texture and flavor. The resulting sweet potato slices have a crispy cookie-like texture after the finishing portion 108 is completed. In addition, the sweet potato slices are preserved after the finishing portion 108 is completed.

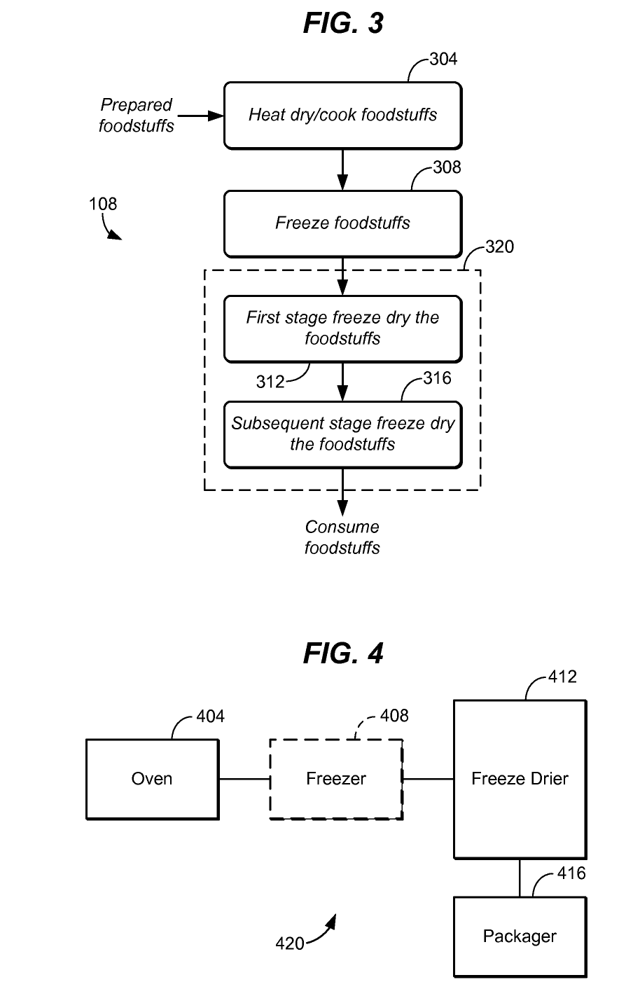

FIG. 3 is a flow diagram illustrating another exemplary finishing portion 108. As can be seen, prepared foodstuffs may be heat dried, baked, cooked, or various combinations thereof at a step 304. Prepared foodstuffs may be prepared in a preparation portion as disclosed above. At a step 308, the foodstuffs may be frozen in preparation of one or more freeze drying steps 320. Freezing at step 308 will typically occur in a freezer or freeze drier that rapidly lowers foodstuffs to their eutectic temperature, so as to avoid formation of ice crystals.

It is contemplated that various freeze drying processes may be used. An exemplary multi-stage freeze drying process is shown in FIG. 3 for instance. This exemplary freeze drying process may comprise one or more first freeze drying stages and one or more subsequent freeze drying stages. As shown in FIG. 3, first stage freeze drying occurs at a step 312, while subsequent stage freeze drying occurs at a step 316.

During first stage freeze drying, ice within the foodstuffs is removed by sublimation, such as by lowering pressure in a freeze drier. Heat may be applied to foster sublimation. However, the temperature during first stage freeze drying will typically be below freezing. During second stage freeze drying remaining water may be removed, such as by increasing the heat applied to the foodstuffs, lowering pressure in the freeze dryer or both. It is noted that the first and subsequent stages may be repeated until a desired moisture content is achieved.

One or more measurement tools, such as temperature, pressure, or moisture sensors may be used to verify that freeze drying is occurring as desired and to determine if a desired moisture content is achieved. In one or more embodiments for example, moisture content less than 5% may be the target for foodstuffs.

FIG. 4 illustrates an exemplary freeze dry foodstuff finishing system 420. As can be seen a freeze dry foodstuff finishing system 420 may comprise elements such as one or more ovens 404, freezers 408 and freeze driers 412.

In operation, an oven 404 may be used to heat dry, bake, or cook foodstuffs, such as illustrated by the heat dry step, step 304, of FIG. 3. Thereafter, a freezer 408 may be used to freeze the foodstuffs, such as shown in the freezing step, step 308, of FIG. 3. Freeze drying can then occur in one or more freeze drying steps, such as shown by step 320 of FIG. 3, in a freeze drier 412. It can be seen that the freeze dry foodstuff finishing system 420 may be used to perform the finishing portion of the invention herein.

Once foodstuffs emerge from a freeze drier 412 they may be consumed immediately. In some embodiments, one or more packagers 416 may be included to package the ready-to-consume foodstuffs. A packager 416 will typically wrap or otherwise package the foodstuffs. A packager 416 may comprise one or more packaging machines that enclose the foodstuffs in bags, boxes, cans, bottles or other containers. Some exemplary packaging machines include boxing, filling, sealing and bagging machines.

As can be seen from the connecting lines of FIG. 4, the elements of a freeze dry foodstuff finishing system 420 may be connected to one another. In one or more embodiments, the elements may be connected by machinery that moves foodstuffs therebetween. For example, a conveyor belt or system may be used to move foodstuffs from an oven 404, to a freezer 408, freeze drier 412, packager 416 or various combinations thereof. One or more robotic arms or the like may be provided to automatically insert and remove foodstuffs from various elements of the freeze dry foodstuff finishing system 420. One or more programmable logic controllers may be programmed to control the elements of the freeze dry foodstuff finishing system 420 and to control movement of foodstuffs between such elements.

A programmable logic controller may communicate with one or more measurement tools when determining whether to activate or deactivate an element of the freeze dry foodstuff finishing system 420, and when to move foodstuffs from one element to another. For example, a measurement tool may be used to determine that foodstuffs have reached their eutectic point by measuring their temperature. Determination that heated drying or freeze drying may also occur by measuring the temperature, moisture content or other characteristic of foodstuffs using a measurement tool. Once the eutectic point is reached the programmable logic controller may deactivate the freezer 408 and being the freeze drying procedure, such as by moving the foodstuffs to the freeze drier 412, activating the freeze drier, or both. It is contemplated that a programmable logic controller may generate alerts or notifications to indicate when heated drying, freezing, freeze drying is complete.

It is contemplated that various of the elements of the freeze dry foodstuff finishing system 420 may be integrated or combined with one another. For example, a freezer 408 and freeze drier 412 may be a combined device that both freezes and freeze dries foodstuffs. In such case, a separate freezer 408 would be optional, such as illustrated by the dashed lines of FIG. 4.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method for finishing foodstuffs with a foodstuff finishing system comprising:
slicing one or more raw foodstuffs into a plurality of slices;
applying one or more flavorings to the plurality of slices;
heat drying and baking the plurality of slices in an oven;
after heat drying and baking the plurality of slices, removing the plurality of slices from the oven and freezing the plurality of slices in a freezer; and
after the plurality of slices are frozen, removing the plurality of slices from the freezer and freeze drying the plurality of slices in a freeze drier;
wherein after the plurality of slices are freeze dried, the plurality of slices are ready for immediate consumption without requiring rehydration or other additional processing.

2. The method of claim 1 further comprising packaging the plurality of slices with a packaging machine after the plurality of slices are freeze dried.

3. The method of claim 1 further comprising consuming the plurality of slices after the plurality of slices are freeze dried.

4. The method of claim 1, wherein the plurality of slices are 3/16 inch in thickness.

5. The method of claim 1 further comprising applying a sauce or marinade to the plurality of slices.

6. The method of claim 1 further comprising cleaning the one or more raw foodstuffs.

7. The method of claim 1, wherein heat drying and baking the plurality of slices occurs within a range of 300° F. to 400° F. for 15 to 25 minutes in the oven.

8. A method for finishing foodstuffs with a foodstuff finishing system comprising:
heating a plurality of slices with an oven to dry and bake the plurality of slices;
after heating the plurality of slices, freezing the plurality of slices in a freeze drier; and
after the plurality of slices are frozen, freeze drying the plurality of slices in the freeze dryer;
wherein after the plurality of slices are freeze dried, the plurality of slices are ready for immediate consumption.

9. The method of claim 8 further comprising flavoring the plurality of slices prior to heating the plurality of slices.

10. The method of claim 8 further comprising packaging the plurality of slices with a packaging machine after the plurality of slices are freeze dried.

11. The method of claim 8 further comprising consuming the plurality of slices after the plurality of slices are freeze dried.

12. The method of claim 8 further comprising applying a sauce or marinade to the plurality of slices.

13. The method of claim 8, wherein heating the plurality of slices occurs at within a range of 300° F. to 400° F. for 15 to 25 minutes in the oven.

14. The method of claim 8, wherein the plurality of slices are 3/16 inch in thickness.

15. A freeze dry foodstuff finishing system comprising:
one or more ovens that receive a plurality of slices and dry and bake the plurality of slices;
one or more freezers that receive and freeze the plurality of slices after the slices have been dried and baked by the one or more ovens; and
one or more freeze driers that receive and freeze dry the plurality of slices after the slices have been frozen by the one or more freezers;
wherein after the plurality of slices are freeze dried by the one or more freeze driers, the plurality of slices are ready for immediate consumption.

16. The freeze dry foodstuff finishing system of claim 15, wherein the one or more ovens heat and dry the plurality of slices within a range of 300° F. to 400° F. for 15 to 25 minutes.

17. The freeze dry foodstuff finishing system of claim 15 further comprising a conveyor system that moves the plurality of slices between the one or more ovens, the one or more freezers, and the one or more freeze driers.

18. The freeze dry foodstuff finishing system of claim 15 further comprising one or more packaging machines that package the plurality of slices after the plurality of slices are freeze dried.

19. The freeze dry foodstuff finishing system of claim 15 further comprising one or more programmable logic controllers that control the heating and drying, freezing and freeze drying of the plurality of slices.

20. The freeze dry foodstuff finishing system of claim 15, wherein the plurality of slices are 3/16 inch in thickness.
